(19) United States
(12) Patent Application Publication
(10) Pub. No.: US 2026/0348646 A1
(43) Pub. Date: Nov. 5, 2026

(54) REFRIGERATOR

(71) Applicant: LG Electronics Inc., Seoul (KR)

(72) Inventor: Dahan YE, Seoul (KR)

(21) Appl. No.: 19/651,236

(22) Filed: Apr. 17, 2026

(30) Foreign Application Priority Data
Apr. 30, 2025 (KR) 10-2025-0056938

(51) Int. Cl. F25D 23/02

(52) U.S. Cl. CPC F25D 23/028; F25D 2323/024

(57) ABSTRACT

A refrigerator includes a cabinet, a door, a door mounting bracket on a cap deco, and a hinge assembly may be fastened to the door mounting bracket in multiple directions including a first direction and a second direction intersecting the first direction, thereby distributing a fastening location and fastening direction.

### CROSS-REFERENCE TO RELATED APPLICATION

This application claims priority to and the benefit of Korean Patent Application No. 10-2025-0056938, filed on Apr. 30, 2025, the disclosure of which is incorporated herein by reference in its entirety.

### BACKGROUND

The present disclosure relates to a refrigerator including a hinge that rotates a door.

A refrigerator is a home appliance for supplying cold air generated using circulation of refrigerant to a storage compartment to keep various types of storage items fresh for a long time. Generally, the refrigerator may include a cabinet, a door for opening and closing the cabinet, and a hinge structure fastened to the door for smooth opening and closing.

Recently, various types of hinge structures have been proposed for refrigerators to improve user convenience and enhance aesthetic appeal, and in particular, products in which a refrigerating compartment door and a freezing compartment door, which are divided into upper and lower sections, are independently opened and closed are increasing. In this case, the hinge structure plays a crucial role not only in opening and closing the door but also in ensuring accurate alignment and stable opening and closing of the door.

For example, a double hinge structure for independently supporting the refrigerating compartment door and the freezing compartment door has been proposed, but such a structure is merely a physical combination of two hinges into a single structure. That is, there is a problem in that specific designs for effectively coupling a hinge to a door or increasing fastening strength and durability have not been presented. Accordingly, conventional hinge structures have faced many limitations in applying them to products with various designs or in a narrow space.

In particular, in cases in which a space from an outer edge to an interior of the product is limited, such as built-in models, when attempting to install the hinge near an outer edge of the door, there has been a problem in that a limited space on left and right sides makes it difficult to securely fasten the hinge. Accordingly, conventional double hinge structures have been applicable only to specific products in which sufficient space is secured on the left and right sides, and there has been a problem in that their application range is significantly limited in general refrigerator models or products having limited space.

For example, in the case of a built-in refrigerator, a method in which a hinge and a door are fastened from the front and then a front panel is assembled may be employed, but such a method is difficult to apply to a general refrigerator that does not employ a separate front panel.

In addition, when a door mounting bracket that mounts the hinge to the door is disposed outside the door and fastened to the hinge, the risk of damage to the door mounting bracket can increase, and the aesthetic appearance of the product can also be impaired.

Accordingly, there is a need to develop a specific fastening structure between a hinge and a door that may be applied not only to built-in refrigerators but also to general refrigerators, and a method for ensuring reliability through such a structure.

### SUMMARY

The present disclosure is directed to providing a refrigerator capable of distributing a fastening location and fastening direction between a hinge assembly and a door mounting bracket.

The present disclosure is also directed to providing a refrigerator capable of securing a robust fastening force between a hinge assembly and a door even in a narrow space.

The present disclosure is also directed to providing a refrigerator capable of making an opening and closing force of a door as uniform as possible and reducing the deformation of a hinge.

The present disclosure is also directed to providing a refrigerator capable of reducing the risk of damage to a door mounting bracket and improving the aesthetic appearance of a product.

The present disclosure is also directed to providing a refrigerator capable of effectively fixing a location of a door mounting bracket disposed inside a door.

The present disclosure is also directed to providing a refrigerator capable of simplifying a fastening structure by a door mounting bracket and reducing material costs.

The present disclosure is also directed to providing a refrigerator capable of distributing an increase in fatigue and concentration at a hinge fastening portion.

The present disclosure is also directed to providing a refrigerator capable of maintaining high rigidity and reliability without shaking or deformation of a bracket even when a door is repeatedly opened and closed.

The present disclosure is also directed to providing a refrigerator capable of increasing a pressing force so that a hinge mounting bracket and a hinge mounting plate are in close contact with each other.

The present disclosure is also directed to providing a refrigerator capable of having excellent internal space utilization and saving space.

The present disclosure is also directed to providing a refrigerator capable of stably distributing a three-axis moment generated during rotation of a hinge.

Objects of the present disclosure are not limited to the above objects, and other objects and advantages of the present disclosure that are not described can be understood by the following description and will be more clearly understood by various embodiments of the present disclosure. In addition, it will be able to be easily seen that the objects and advantages of the present disclosure may be achieved by devices and combinations thereof that are described in the claims.

According to one embodiment of the present disclosure, there is provided a refrigerator including a cabinet including one or more storage compartments, one or more doors configured to open and close the storage compartments, a hinge assembly connected to the door and the cabinet so that the door is rotatable from the cabinet, and a door mounting bracket disposed on an inner surface of a cap deco configured to finish an upper or lower surface of the door, wherein the hinge assembly is fastened to the door mounting bracket in a first direction and a second direction intersecting the first direction with the cap deco interposed therebetween.

The door mounting bracket may have a bent shape to surround a front surface and an upper surface or the front surface and a lower surface of the cap deco.

The door mounting bracket may be located within an insulation space formed within the door.

The hinge assembly may include a hinge member including a plurality of joints, and a hinge mounting bracket and a hinge mounting plate which fasten the hinge member to the door mounting bracket in the first direction and the second direction, respectively.

The door mounting bracket and the hinge mounting bracket may be coupled by a first direction fastening member which is fastened and unfastened in the first direction.

The hinge mounting plate, the cap deco, and the door mounting bracket may be coupled by a second direction fastening member which is fastened and unfastened in the second direction.

A plurality of step adjustment sheets may be disposed between the hinge mounting plate and the cap deco to adjust a vertical step of the door through movement or separation thereof.

The step adjustment sheet may include a relief portion through which the second direction fastening member passes and which does not interfere with the second direction fastening member when the step adjustment sheet is moved or separated.

The hinge mounting plate may include a catch portion which is hook-coupled to the hinge mounting bracket in the second direction, and the catch portion may press the hinge mounting bracket in a direction in which the second direction fastening member is fastened.

The refrigerator may further include a second direction fixing member passing through the hinge mounting bracket, the hinge member, and the hinge mounting plate in the second direction,

A gap adjustment sheet may be further disposed between the hinge member and the hinge mounting plate, and the second direction fixing member may pass through the gap adjustment sheet.

The hinge assembly and the hinge mounting bracket may be hook-coupled in a third direction intersecting the first direction and the second direction.

The door mounting bracket may include a hook portion protruding in a direction toward an interior of the door, a front surface of the cap deco may include an opening which is open such that the hook portion is exposed in the direction toward the interior of the door, and the hinge mounting bracket may include a hook insertion portion which is open such that the hook portion is inserted.

A length of the hook insertion portion in the third direction may be greater than a length of the hook portion.

The door mounting bracket may include an insertion hole communicating with the opening, the hook portion may be formed on one side of the insertion hole to protrude in a direction toward a center of the door, and a length of the insertion hole in the third direction may be greater than a length of the hook insertion portion.

The hinge assembly may include a step adjustment member which is fastened and unfastened in a third direction intersecting the first direction and the second direction to adjust a horizontal step of the door, and the step adjustment member may be disposed on one side of the hinge mounting bracket.

The door mounting bracket may include a guide bent portion protruding in a direction toward an interior of the door, a front surface of the cap deco may include an opening slot portion which is open to allow the guide bent portion to pass through the opening slot portion in the direction toward the interior of the door, and the guide bent portion may include a through-hole through which the step adjustment member passes.

The through-hole may include an extended opening hole extending in one direction along a vertical movement direction of the door.

According to another aspect of the present disclosure, there is provided a refrigerator including a cabinet including an upper storage compartment and a lower storage compartment, an upper door and a lower door which respectively open and close the upper storage compartment and the lower storage compartment, and an upper hinge assembly and a lower hinge assembly fixed to an upper surface of the upper door and a lower surface of the lower door, respectively, wherein the upper hinge assembly is fastened to front and upper surfaces of an upper door inner bracket disposed on an upper inner surface of the upper door, and the lower hinge assembly is fastened to front and lower surfaces of a lower door inner bracket disposed on a lower inner surface of the lower door.

The upper hinge assembly and the lower hinge assembly may be single fastening hinge assemblies, and the upper door inner bracket and the lower door inner bracket may be located in insulation spaces formed within the upper door and the lower door, respectively.

In the refrigerator according to one embodiment of the present disclosure, the hinge assembly can be fastened to the door mounting bracket in multiple directions including a first direction and a second direction intersecting the first direction, thereby distributing the fastening location and fastening direction.

Accordingly, the firm fastening force between the hinge assembly and the door can be secured even in a narrow space. In addition, since the hinge moment can be distributed, the opening and closing force can be made as uniform as possible when the door is opened and closed, and the deformation of the hinge can be reduced.

In addition, in the refrigerator according to one embodiment of the present disclosure, the door mounting bracket can be disposed in the insulation space within the door, and the hinge assembly is mounted with the cap deco interposed therebetween, thereby minimizing the region of the door mounting bracket exposed to the outside and thus not only reducing the risk of damage but also improving the aesthetic appearance of the product.

In addition, in the refrigerator according to one embodiment of the present disclosure, by arranging the door mounting bracket in the insulation space within the door, the door mounting bracket can be integrally coupled with the insulating foaming material injected into the insulation space, thereby effectively dispersing an increase and concentration of fatigue at the hinge fastening portion even when the impact load of the door is concentrated on the edge portion of the door.

In addition, in the refrigerator according to one embodiment of the present disclosure, by arranging the door mounting bracket in the insulation space within the door, the door mounting bracket can be pressed by the insulating foaming material filling the insulation space, and thus the location of the door mounting bracket can remain fixed without being changed even when fastening and unfastening between the hinge assembly and the door mounting bracket are repeatedly performed.

In addition, in the refrigerator according to one embodiment of the present disclosure, the door mounting bracket can be formed in the integrated shape having the bent shape that surrounds the front and upper surfaces or front and lower surfaces of the cap deco, thereby simplifying the fastening structure and reducing material costs.

In addition, in the refrigerator according to one embodiment of the present disclosure, by providing the hook coupling structure between the hinge mounting bracket and the hinge mounting plate, the physical stopper effect can be provided during hinge assembly, thereby increasing the pressing force so that the hinge mounting bracket and the hinge mounting plate are more firmly in close contact.

In addition, in the refrigerator according to one embodiment of the present disclosure, in the case of the double fastening hinge assembly, two independent hinge members can be stably supported using a single common cabinet mounting bracket even in a refrigerator model in which a space between a refrigerating compartment and a freezing compartment is narrow, thereby improving utilization of the limited internal space and achieving the space-saving effect.

In addition, in the refrigerator according to one embodiment of the present disclosure, by additionally providing hook-coupling in the third direction intersecting the first direction and the second direction between the door mounting bracket and the hinge mounting bracket, separation of the bracket can be minimized even under the impact load applied to the door, and the three-axis moment generated during hinge rotation can be stably dispersed.

Specific effects of the present disclosure together with the above effects will be described with a description of the following detailed matters for carrying out the invention.

### BRIEF DESCRIPTION OF THE DRAWINGS

FIG. 1 is a front perspective view of a refrigerator when a door is in an open state.

FIG. 2 is an enlarged view illustrating an upper region of a first door connected to a cabinet by a first hinge assembly when the first door is in a closed state.

FIG. 3 is an enlarged view illustrating the first hinge assembly fastened to the upper region of the first door when the first hinge assembly is in an unfolded state.

FIG. 4 is an enlarged view illustrating a lower region of a second door connected to the cabinet by a third hinge assembly when the second door is in an open state.

FIG. 5 is an exploded perspective view of a hinge member of the first hinge assembly, an upper door mounting bracket, the first door, and a first upper cap deco.

FIG. 6 is a view illustrating a state in which a hinge mounting bracket and a hinge mounting plate of the first hinge assembly are separated.

FIG. 7 is a view illustrating the first hinge assembly in a state in which the hinge mounting bracket and the hinge mounting plate are fastened.

FIGS. 8 and 9 are front and rear views respectively illustrating the upper door mounting bracket fastened to an inner surface of the first upper cap deco.

FIG. 10 is a view illustrating the first hinge assembly fastened to the upper door mounting bracket of the first door.

FIGS. 11 and 12 are side cross-sectional views in a front-rear direction, respectively, as viewed in the direction indicated in FIG. 10.

FIGS. 13 and 14 are enlarged views respectively illustrating locational changes of a fastening member within a fastening hole in the second direction as the first door is step-adjusted in a horizontal direction.

FIG. 15 is an enlarged view of a portion of the first hinge assembly hook-coupled in the horizontal direction to the upper door mounting bracket of the first door.

FIGS. 16 and 17 are side cross-sectional views in the horizontal direction and a vertical direction, respectively, as viewed in the direction indicated in FIG. 15.

FIG. 18 is a side cross-sectional view in a state in which the first hinge assembly is mounted on an upper portion of the first door.

FIGS. 19 and 20 are an exploded perspective view and an assembled perspective view of a second hinge assembly including a step adjustment sheet according to another embodiment.

### DETAILED DESCRIPTION

The above objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted. Hereinafter, exemplary embodiments according to the present disclosure will be described in detail with reference to the accompanying drawings. In the drawings, the same reference numerals are used to denote the same or similar components.

Although the terms “first,” “second,” etc., are used to describe various components, it is apparent that these components are not limited by these terms. These terms are used only to distinguish one component from another, and unless otherwise stated, it is obvious that a first component may be a second component. Throughout the specification, unless otherwise stated, each component may be singular or plural.

Hereinafter, the arrangement of an arbitrary component on an “upper portion (or lower portion)” of a component or “above (or under)” the component may not only mean that the arbitrary component is disposed in contact with an upper surface (or a lower surface) of the component, but also mean that other components may be interposed between the component and the arbitrary component disposed above (or under) the component.

In addition, when a certain component is described as being “connected,” “coupled,” or “joined” to the other component, the components may be directly connected or joined, but it should be understood that another component may be “interposed” between the components, or the components may be “connected,” “coupled,” or “joined” through another component.

The singular expression used herein includes the plural expression unless the context clearly dictates otherwise. In the application, terms such as “composed of” or “comprising” should not be construed as necessarily including all of the various components or operations described in the specification and should be construed as not including some of the components or some of the operations or further including additional components or operations.

Hereinafter, a refrigerator according to some embodiments of the present disclosure will be described.

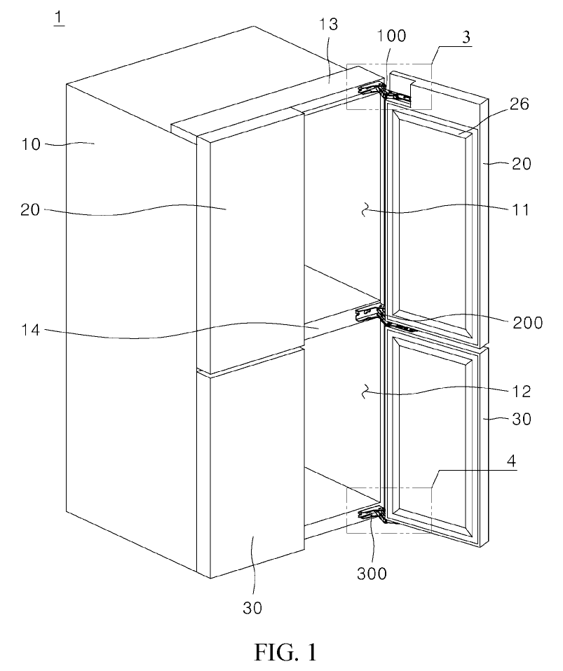

First, a hinge assembly connecting a cabinet and door of a refrigerator according to one embodiment of the present disclosure and a connection relationship of major components constituting the hinge assembly will be described with reference to FIGS. 1 -4.

A refrigerator 1 may have the appearance formed by a cabinet 10 including one or more storage compartments, which are product storage spaces, and one or more doors capable of opening and closing an open front surface of the cabinet 10. The cabinet 10 may include an outer case forming an outer surface of the refrigerator 1 and an inner case forming an inner surface thereof with an insulation space interposed therebetween. An interior of the inner case may be divided into one or more storage spaces. For example, the cabinet 10 may include a first storage compartment 11 and a second storage compartment 12 disposed in the vertical direction with a barrier portion interposed therebetween. For example, an insulating foam material, which is an insulation member, may be injected into the insulation space, and the insulation space may be filled with the insulating foam material.

For example, the first storage compartment 11 and the second storage compartment 12 may be opened and closed by a pair of first doors 20 and a pair of second doors 30, which are disposed side by side in the horizontal direction, respectively. The first door 20 may be rotatably connected to the cabinet 10 by a first hinge assembly 100 and a second hinge assembly 200 that are coupled to upper and lower ends thereof, respectively. In addition, a second door 30 may be rotatably connected to the cabinet 10 by the second hinge assembly 200 and a third hinge assembly 300 that are coupled to upper and lower ends thereof, respectively. The first hinge assembly 100 and the third hinge assembly 300 may be single-fastening hinge assemblies that are fastened to one door through a single hinge member. In addition, the second hinge assembly 200 may be a double-fastening hinge assembly connected to two doors through two hinge members. A hinge cover 13 may be disposed on an upper surface of the cabinet 10. For example, the hinge cover 13 may be disposed at a front end of the upper surface of the cabinet 10 to cover an upper surface of the first hinge assembly 100.

In this way, the first hinge assembly 100 fixed to an upper surface of an upper door may be referred to as an upper hinge assembly, the third hinge assembly 300 fixed to a lower surface of a lower door may be referred to as a lower hinge assembly, and the second hinge assembly 200 fixed to a lower surface of the upper door and an upper surface of the lower door may be referred to as a middle hinge assembly.

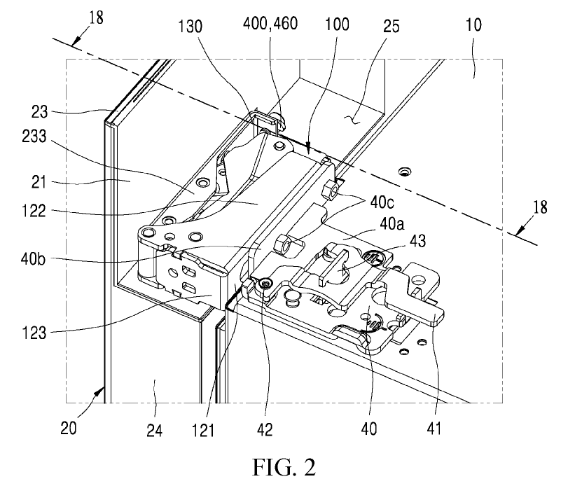

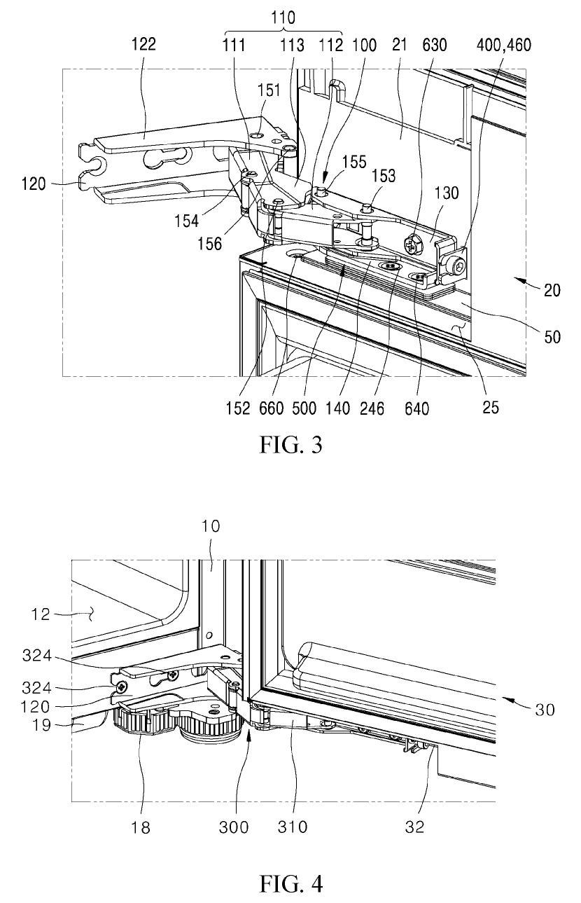

FIG. 2 is an enlarged view illustrating an upper region of the first door 20 connected to the cabinet 10 by the first hinge assembly 100 when the first door 20 is in a closed state, and FIG. 3 is an enlarged view illustrating an upper region of the first door 20 connected by the first hinge assembly 100 when the first hinge assembly 100 is in an unfolded state.

Upper and lower surfaces of the first door 20 may be finished by a first upper cap deco 21 and a first lower cap deco, respectively; front and rear surfaces thereof may be finished by a front plate 23 and a door liner 26, respectively; and both side surfaces thereof may be finished by a pair of side frames 24. The second door 30 to be described below may also be configured to have the same structure. In the present specification, the front surface refers to the surface facing forward toward a user when the door is in a closed state, and the rear surface refers to the surface facing rearward. Accordingly, the direction connecting the front and rear surfaces of the door may be the front-rear direction, and the direction connecting the two side surfaces of the door may be the horizontal direction.

A cabinet fixing bracket 40 may be disposed at the front end of the upper surface of the cabinet 10. The cabinet fixing bracket 40 may include a support 40a fastened to the upper surface of the cabinet 10, and a fixing portion 40b bent upward from a front end of the support 40a so as to face forward. A restraining member 41 connected to be rotatable about a rotational pin 42 provided on one side of the support 40a may be disposed on the support 40a. A restraining rib 43 fastened by passing through the restraining member 41 in the vertical direction to prevent the restraining member 41 from being removed may be disposed on the restraining member 41.

The first hinge assembly 100 may be located in a first hinge mounting portion 25 formed in the first upper cap deco 21. The first hinge mounting portion 25 may be formed such that a rear surface and one side surface are open and a front and the other side surface are closed. A door mounting bracket 400 may be disposed on the first hinge mounting portion 25. The door mounting bracket 400 may fasten the first hinge assembly 100 to the first door 20. The door mounting bracket 400 may be disposed on an inner surface of the first upper cap deco 21, except for a portion of a fastening portion for fastening with the first hinge assembly 100. Accordingly, the door mounting bracket 400 may be referred to as a first door inner bracket 460 or an upper door inner bracket 460.

The first hinge assembly 100 may include a first cabinet mounting bracket 120. The first cabinet mounting bracket 120 may be fastened to a fastening portion 40c formed on the fixing portion 40b of the cabinet fixing bracket 40 through a fastening member. Accordingly, one side of the first hinge assembly 100 may be fixed to the front surface of the cabinet 10. The first cabinet mounting bracket 120 may include a base portion 121 fastened to the fixing portion 40b, a pair of extensions 122 formed to extend forward from upper and lower ends of the base portion 121, and a side portion 123 extending forward from a side end of the base portion 121 to connect the pair of extensions 122.

The first hinge assembly 100 may include a first hinge mounting bracket 130. The first hinge mounting bracket 130 may include a bracket body portion 231 fastened to one surface of the door mounting bracket 400 bent forward, and a pair of bracket coupling portions 233 formed to extend rearward from upper and lower ends of the bracket body portion 231. The first hinge mounting bracket 130 may be fastened to the door mounting bracket 400 through a fastening member passing through the bracket body portion 231. Accordingly, the other side of the first hinge assembly 100 may be fixed to the first hinge mounting portion 25 of the first door 20.

At least a portion of a hinge member 110 having a multi-joint hinge structure in which a plurality of joints are joined may be stored within the first cabinet mounting bracket 120 and the first hinge mounting bracket 130. A rotational trajectory of the hinge member 110 may be determined by a plurality of joint joining structures constituting the hinge member 110. Accordingly, the first door 20 may be opened at an opening angle and trajectory that does not interfere with furniture, walls, etc. disposed on the side thereof.

For example, the hinge member 110 may include a plurality of joints including a first link 111, a second link 112, and a third link 113. The joints that are axially coupled may generally be formed in a quadrilateral shape and may provide a rotational trajectory along which the first door 20 may be rotated by folding or unfolding.

One side of the first link 111 may be axially coupled to the first cabinet mounting bracket 120 via a first rotational shaft 151 disposed between the pair of extensions 122, and the other side may be axially coupled to the second link 112 via a second rotational shaft 152.

One side of the second link 112 may be axially coupled to the first link 111 via the second rotational shaft 152, and the other side may be axially coupled to the first hinge mounting bracket 130 via a third rotational shaft 153 disposed between the pair of bracket coupling portions 233. For example, a spring for forcing rotation of the second link 112 by being tensioned or compressed as the second link 112 rotates. The spring may be compressed during the process of closing the first door 20 and restored just before the second door 30 is closed.

One side of the third link 113 may be axially coupled to the first link 111 via a fourth rotational shaft 154, and the other side may be axially coupled to the first hinge mounting bracket 130 via a fifth rotational shaft 155 disposed between the pair of bracket coupling portions 233. For example, the first cabinet mounting bracket 120 and the third link 113 may be connected by a linear damper. One side of the linear damper may be axially coupled to the first cabinet mounting bracket 120 via a sixth rotational shaft 156 disposed between the pair of extensions 122, and the other side may be coupled to the third link 113. The linear damper can reduce a rotational speed and mitigate an impact when the first door 20 is closed. Through operations of the linear damper and the spring, the plurality of links constituting the hinge member 110 may rotate smoothly while maintaining a set trajectory.

The first hinge assembly 100 may include a first hinge mounting plate 140. The first hinge mounting plate 140 may be disposed horizontally so as to be orthogonal to the bracket body portion 231 of the first hinge mounting bracket 130. The first hinge mounting plate 140 may be fastened to the first hinge mounting bracket 130 and the hinge member 110 by the third rotational shaft 153 and the fifth rotational shaft 155 passing through the first hinge mounting plate 140. For example, the third rotational shaft 153 and the fifth rotational shaft 155 may be formed of rivets.

One or more step adjustment sheets 500 capable of adjusting a vertical step of the first door 20 may be disposed on a lower surface of the first hinge assembly 100. The step adjustment sheet 500 may be disposed between the first hinge mounting plate 140 and the first upper cap deco 21. For example, the step adjustment sheet 500 may be fixed to a lower surface of the first hinge mounting plate 140 in a form that may be separated from the first hinge mounting plate 140.

Referring to FIG. 4, the third hinge assembly 300 may be located on a hinge mounting portion formed on a second lower cap deco 32. One side of the hinge member 310 included in the third hinge assembly 300 may be fixed to the front surface of the cabinet 10 by the cabinet mounting bracket 120, and the other side may be fastened to the lower surface of the second lower cap deco 32. The cabinet mounting bracket 120 may be fastened to the front surface of the cabinet 10 by one or more fastening members 324. A height adjustment portion 18 for adjusting the height of the cabinet 10 and a roller portion 19 for assisting in moving the cabinet 10 may be disposed on the lower surface of the cabinet 10. The third hinge assembly 300 is preferably disposed above the height adjustment portion 18 or the roller portion 19 so that an unfolding or folding motion is not interfered with.

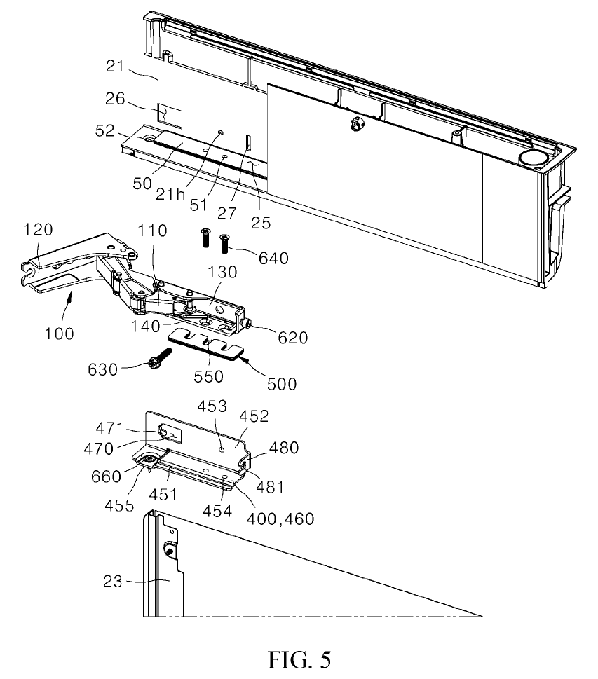

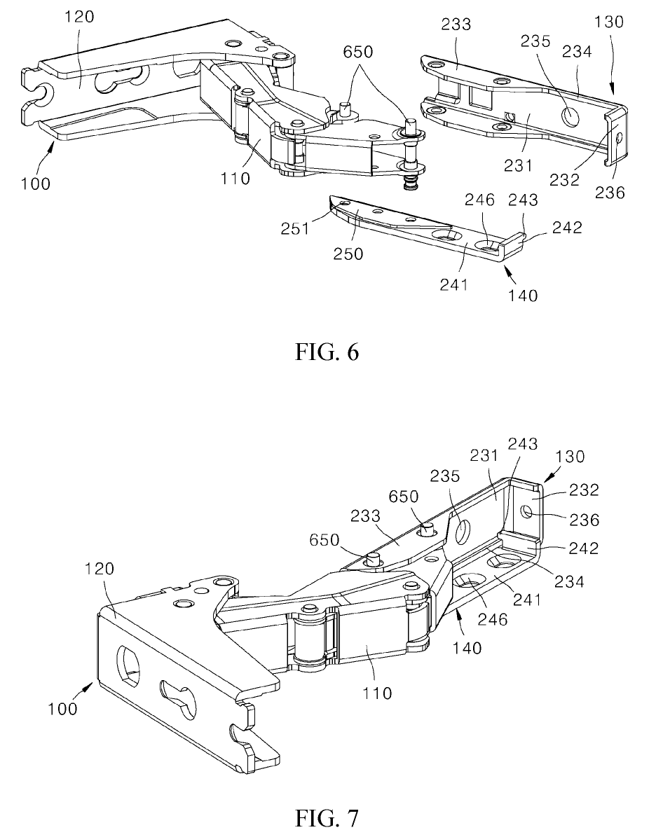

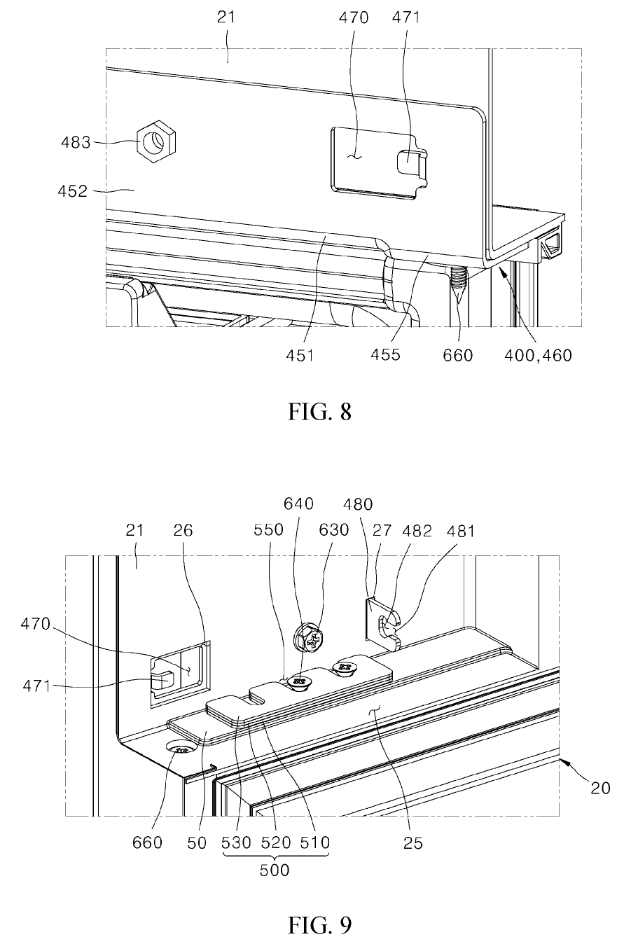

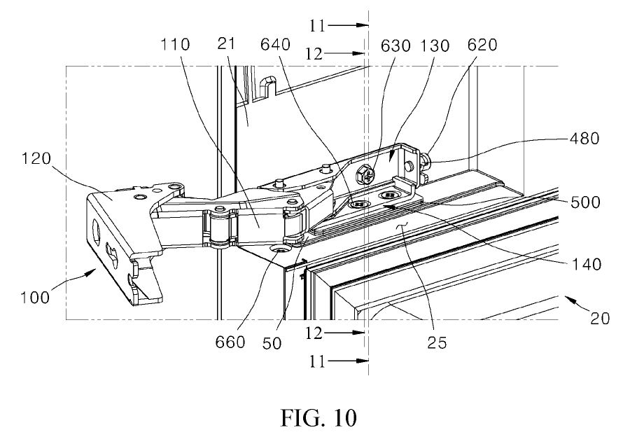

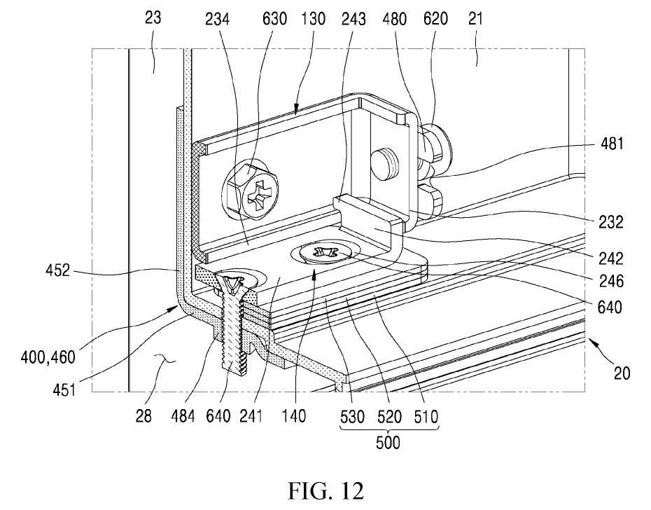

Hereinafter, the fastening structure between the hinge assembly and the door will be described in more detail with further reference to FIGS. 5-18 using the fastening structure between the first hinge assembly 100 and the first door 20 as an example.

The hinge member 110, the first hinge mounting bracket 130, and the first hinge mounting plate 140 of the first hinge assembly 100, and a plurality of step adjustment sheets 500 may be disposed on an upper outer surface of the first upper cap deco 21, and the door inner bracket 460 may be disposed on a lower inner surface of the first upper cap deco 21. The door inner bracket 460 may be fastened to the first hinge assembly 100 with the first upper cap deco 21 interposed therebetween.

The first hinge mounting bracket 130 of the hinge member 110 may be connected to the door inner bracket 460 by a first direction fastening member 630 fastened and unfastened in the first direction, which is the front-rear direction. In addition, the first hinge mounting bracket 130 and the first hinge mounting plate 140 of the hinge member 110 may be fastened by a second direction fixing member 650 passing therethrough in the second direction, which is the vertical direction. The second direction may intersect the first direction. For example, the first direction and the second direction may be orthogonal to each other.

In this case, the second direction fixing member 650 may constitute the third rotational shaft 153 and the fifth rotational shaft 155 of the hinge member 110. In addition, the first hinge mounting bracket 130 and the first hinge mounting plate 140 of the first hinge assembly 100 may be fastened to the door inner bracket 460 by the second direction fixing member 650.

Accordingly, the first hinge assembly 100 may be fastened to the door inner bracket 460 in the first direction and the second direction intersecting the first direction. In addition, the first hinge mounting bracket 130 may fasten the hinge member 110 to the door inner bracket 460 in the first direction, and the first hinge mounting plate 140 may fasten the hinge member 110 to the door inner bracket 460 in the second direction.

The first hinge mounting bracket 130 fastened to one side of the hinge member 110 may include a bracket body portion 231 that extends in the horizontal direction. The bracket body portion 231 may be disposed so that a surface having a large area faces forward. One or more screw holes 235 passing through the bracket body portion 231 in the front-rear direction may be formed in the bracket body portion 231. At upper and lower ends of one side of the bracket body portion 231, the bracket coupling portion 233 that is bent horizontally and extends rearward may be formed, thereby providing a rotational shaft fastened to the hinge member 110.

On the other side of the bracket body portion 231, a bracket bent portion 232 that is bent vertically from a side end and extends rearward may be formed. A screw hole 236 passing through the bracket bent portion 232 in the horizontal direction may be formed in the bracket bent portion 232, and a step adjustment member 620 may be fastened through the screw hole 236. For example, the step adjustment member 620 may be a bolt member or a screw member that can be easily fastened and unfastened by a screw fastening method. The step adjustment member 620 may be fastened and unfastened outward from the bracket bent portion 232, thereby increasing the user’s workability. The step adjustment member 620 may include a head portion 621 and a shaft portion 622 that extends cylindrically from one side of the head portion 621 and has screw threads formed on an outer circumferential surface thereof. For example, a user may rotate the head portion 621 using a tool such as a wrench or screwdriver to fasten and unfasten the step adjustment member 620.

A catch 234 may be formed along a rear edge portion formed at the upper and lower ends of the bracket body portion 231. For example, the catch 234 may protrude rearward along the same line as the bracket coupling portion 233 and protrude by a length shorter than that by which the bracket coupling portion 233 extends rearward. The catch 234 may be formed to be continuously connected from the rear edge portion of the bracket body portion 231 to a rear edge portion of the bracket bent portion 232. The catch 234 may reinforce the strength of the first hinge mounting bracket 130. In addition, the catch 234 may be used to increase the fastening force with the first hinge mounting plate 140 in an upward or downward direction.

The first hinge mounting plate 140 may include a plate body portion 241 that extends in the horizontal direction. The plate body portion 241 may be disposed to be orthogonal to the bracket body portion 231 of the first hinge mounting bracket 130. Accordingly, the bracket body portion 231 may be disposed to face a front surface of the second door 30, and the plate body portion 241 may be disposed to face an upper surface of the second door 30.

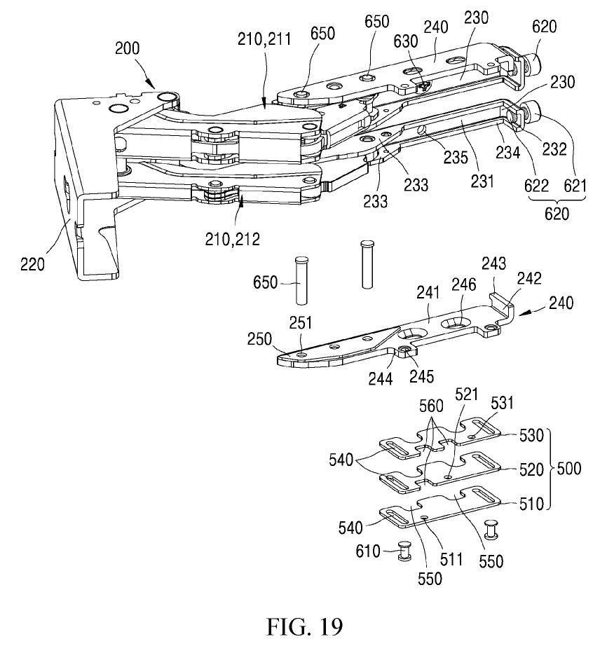

A plate bent portion 242 that is bent upward and extends may be formed at one side end of the plate body portion 241. A catch portion 243 that protrudes forward may be formed at an upper end of the plate bent portion 242 facing forward. Referring to FIG. 19, when the first hinge mounting plate 140 is fastened to the first hinge mounting bracket 130, the catch portion 243 that protrudes forward may be caught on an upper surface of the catch 234 that protrudes rearward, thereby enabling engagement by a catch or a hook. That is, the catch portion 243 of the first hinge mounting plate 140 may press the catch 234 of the first hinge mounting bracket 130 downward, thereby increasing the fastening force between the first hinge mounting bracket 130 and the first upper cap deco 21. The catch portion 243 may press the first hinge mounting bracket 130 in a direction in which a second direction fastening member 640 is fastened.

When the catch portion 243 is fastened to the catch 234, the catch portion 243 may be disposed adjacent to the bracket bent portion 232. In this case, since the step adjustment member 620 capable of repeated fastening and unfastening is fastened to the bracket bent portion 232, the catch portion 243 is preferably spaced apart from the end portion of the step adjustment member 620 passing through the bracket bent portion 232 by a predetermined distance or disposed below the step adjustment member 620.

As described above, in the refrigerator according to one embodiment of the present disclosure, by providing the hook coupling structure between the hinge mounting bracket and the hinge mounting plate, the physical catch effect can be provided during hinge assembly, thereby increasing the pressing force so that the hinge mounting bracket and the hinge mounting plate are more firmly in close contact.

One or more fastening holes 246 passing through the plate body portion 241 in the vertical direction may be formed in the plate body portion 241. The fastening holes 246 may be formed in the shape of elongated holes extending in the horizontal direction through which the step adjustment member 620 is fastened and unfastened. That is, the extension direction of the elongated hole of the fastening hole 246 may correspond to the horizontal movement direction of the second door 30 for horizontal step adjustment. A pair of fastening holes 246 may be disposed side by side in the horizontal direction. The second direction fastening member 640 fastened and unfastened in the vertical direction, which is a second direction orthogonal to the first direction, may be fastened to the fastening hole 246. For example, the second direction fastening member 640 may be a screw member or a bolt member.

One or more step adjustment sheets 500 may be disposed on a lower portion of the plate body portion 241. For example, the step adjustment sheet 500 may include a first step adjustment sheet 510, a second step adjustment sheet 520, and a third step adjustment sheet 530 that are stacked sequentially from the bottom to the top. Each step adjustment sheet 500 may be formed to generally have a plate shape. For example, the step adjustment sheet 500 may have a plate shape in which a length in the horizontal direction is greater than a length in the front-rear direction.

For example, a plurality of step adjustment sheets 500 may be formed in a form that is not constrained by a hinge assembly and completely separated. For example, the step adjustment sheet 500 may generally have a plate shape and may be formed to include a relief portion 550 for preventing interference with the second direction fastening member 640 during insertion and withdrawal.

In a state in which the step adjustment sheets 500 are inserted into the lower surface of the first hinge mounting plate 140, the step adjustment sheets 500 may be disposed to vertically overlap the fastening hole 246 of the plate body portion 241. In this case, since the fastening hole 246 is penetrated by the second direction fastening member 640, the step adjustment sheet 500 may also interfere with the second direction fastening member 640. Accordingly, the step adjustment sheet 500 may include the relief portion 550 that has an opening that vertically overlaps the fastening hole 246. That is, in a state in which the step adjustment sheet 500 is fully inserted, the fastening hole 246 and the relief portion 550 may be disposed to vertically overlap each other.

The relief portion 550 may be formed as a pair in a front region of the step adjustment sheet 500. Accordingly, even in a state in which the step adjustment sheet 500 is fully inserted, the second direction fastening member 640 passing through the fastening hole 246 may extend downward through the relief portion 550. In this way, even when the step adjustment sheet 500 is inserted and withdrawn in the front-rear direction due to the relief portion 550 of the step adjustment sheet 500, the step adjustment sheet 500 may be freely inserted and withdrawn without interfering with the second direction fastening member 640.

The second direction fastening member 640 may guide each step adjustment sheet 500 to move in the front-rear direction. Each step adjustment sheet 500 may horizontally move along the second direction fastening member 640. For example, each step adjustment sheet 500 may be inserted and withdrawn in a sliding manner along the second direction fastening member 640. In this way, as a plurality of step adjustment sheets 500 are horizontally inserted and withdrawn in a sliding manner, the step adjustment sheets 500 may be moved selectively and independently.

In this way, the refrigerator according to one embodiment of the present disclosure is configured so that the step adjustment sheet for adjusting the vertical step of the door moves horizontally or is inserted and withdrawn in a sliding manner, thereby enabling convenient and smooth vertical step adjustment even in narrow installation environments.

In addition, the refrigerator according to one embodiment of the present disclosure can accurately guide a movement trajectory of the step adjustment sheet by guiding movement of the step adjustment sheet so that the step adjustment sheet moves only along a designated path. Accordingly, the step adjustment sheet can be prevented from being unnecessarily removed or damaged during the step adjustment process, and stable and repeated step adjustment can be achieved even in a narrow installation environment.

Meanwhile, a gap adjustment sheet 250 may be disposed between the bracket coupling portion 233 of the first hinge mounting bracket 130 and the first hinge mounting plate 140. The gap adjustment sheet 250 may be disposed on an upper surface of the first hinge mounting plate 140 and formed in a shape that substantially corresponds to the bracket coupling portion 233. The gap adjustment sheet 250 may be formed in a plate shape having a predetermined thickness in the vertical direction. The first hinge mounting plate 140 and the first hinge mounting bracket 130 may be fastened to each other while being spaced apart from each other by a thickness of the gap adjustment sheet 250.

Accordingly, interference between the hinge member 110 and the first hinge mounting plate 140 can be prevented during folding and unfolding operations of the hinge member 110. In addition, when the door sags due to its own weight during long-term use of the refrigerator 1, interference may occur as a distance between the hinge member 110 and the first hinge mounting plate 140 becomes smaller than a distance at the time of initial installation. Accordingly, the gap adjustment sheet 250 may create a buffer region of a predetermined distance between the hinge member 110 and the first hinge mounting plate 140 in advance, in consideration of such door sagginess, thereby improving operational reliability even when the refrigerator is used for a long time. In addition, the gap adjustment sheet 250 may substantially serve to adjust a maximum angle of the first door 20.

A through-hole 251 through which the second direction fixing member 650 passes may be formed in the gap adjustment sheet 250. In addition, the through-hole 251 may also be formed in the first hinge mounting plate 140 to correspond to the through-hole 251 of the gap adjustment sheet 250. Accordingly, the second direction fixing member 650 vertically passing through the first hinge mounting bracket 130 and the first hinge mounting plate 140 may also be fastened with the first hinge mounting bracket 130 and the first hinge mounting plate 140 through the gap adjustment sheet 250.

Meanwhile, the first door inner bracket 460, which is the door mounting bracket 400, may be mounted on the lower inner surface of the first upper cap deco 21 that finishes the upper surface of the first door 20. For example, the first hinge mounting portion 25 may be formed on an upper outer surface of the first upper cap deco 21 in a form in which one side surface and rear surface adjacent to the first hinge assembly 100 are open and the front surface and other side surface thereof are closed. A stepped portion 50 protruding by a predetermined thickness may be formed on the first hinge mounting portion 25. That is, the stepped portion 50 having a predetermined area may be formed on a portion of the first upper cap deco 21 such that the plurality of step adjustment sheets 500 and the first hinge assembly 100 may be disposed on the stepped portion 50.

The first door inner bracket 460 may include a first plate 451 fastened to the lower inner surface of the first upper cap deco 21, and a second plate 452 bent upward from a front end of the first plate 451 and fastened to an inner front surface of the first upper cap deco 21. A fastening hole 454 through which the second direction fastening member 640 passes in the front-rear direction and is fastened may be formed in the first plate 451. A through-hole 51 may be formed in the upper surface of the first upper cap deco 21 to correspond to the fastening hole 454 of the first plate 451. The second direction fastening member 640 may be fastened to the fastening hole 454 of the first plate 451 through the through-hole 51 of the first upper cap deco 21. Accordingly, the second direction fastening member 640 can further enhance the fastening force between the first hinge assembly 100 and the first door 20 by fastening the first hinge mounting plate 140, the first upper cap deco 21, and the first door inner bracket 460.

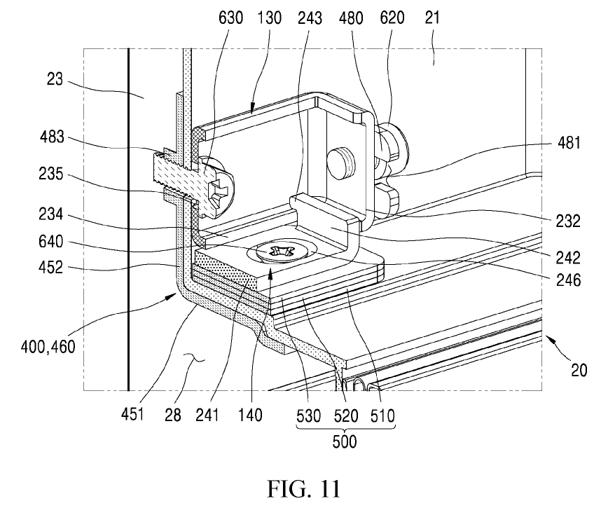

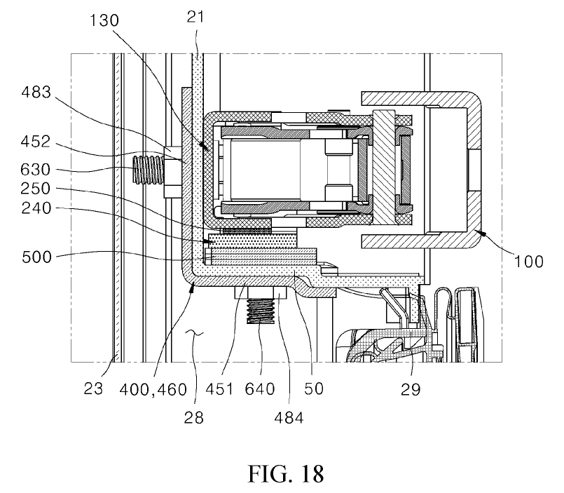

To increase a fastening section between the second direction fastening member 640 and the first door inner bracket 460, the first door inner bracket 460 may include a nut fastening portion 484. Referring to FIGS. 11 and 18, the nut fastening portion 484 may be formed to protrude downward by a predetermined thickness in a state in which the first door inner bracket 460 is disposed on the inner surface of the first upper cap deco 21. The nut fastening portion 484 may be formed to correspond to the fastening hole 454 formed in the first plate 451 of the first door inner bracket 460. The second direction fastening member 640 passing through the first upper cap deco 21 may be fastened to the nut fastening portion 484 of the first door inner bracket 460, thereby increasing the fastening force due to the increased fastening section.

A stepped plate 455 that is recessed downward may be formed on one side of the first plate 451 of the first door inner bracket 460. As described above, since the first upper cap deco 21 may include the stepped portion 50 protruding upward, the first plate 451 of the first upper cap deco 21, which is fastened to the inner surface of the first upper cap deco 21, may be disposed to correspond to the stepped portion 50, and the stepped plate 455 may be disposed to correspond to an outer region of the stepped portion 50. To increase the fastening force between the first upper cap deco 21 and the first door inner bracket 460, a fastening member 660 that passes through and fastens the first upper cap deco 21 and the first door inner bracket 460 may be additionally provided, and the fastening member 660 may pass through the stepped plate 455 in the vertical direction.

The second plate 452 bent upward from the front end of the first plate 451 may be fastened to the bracket body portion 231 of the first hinge mounting bracket 130. Accordingly, the first hinge mounting plate 140 of the first hinge assembly 100 may be fastened to the first plate 451 of the first door inner bracket 460, and the first hinge mounting bracket 130 may be fastened to the second plate 452 of the first door inner bracket 460. The fastening hole 453 passing through the second plate 452 in the front-rear direction may be formed in the second plate 452. The fastening hole 453 of the second plate 452 may be aligned with the screw hole 235 of the first hinge mounting bracket 130 and fastened by the first direction fastening member 630 fastened and unfastened in the front-rear direction. For example, the first direction fastening member 630 may be a screw member or a bolt member. In this case, a fastening hole 21h may be formed in the front surface of the first upper cap deco 21 to correspond to the fastening hole 453 of the second plate 452 and the screw hole 235 of the first hinge mounting bracket 130. Accordingly, the first direction fastening member 630 may pass through the screw hole 235 of the first hinge mounting bracket 130 and the fastening hole 453 of the second plate 452 with the fastening hole 21h formed in the front surface of the first upper cap deco 21 interposed therebetween.

Referring to FIG. 11, an inner diameter of the screw hole 235 formed in the first hinge mounting bracket 130 may be formed to be greater than an inner diameter of the fastening hole 453 formed in the second plate 452. Accordingly, the first direction fastening member 630 may be fastened to the fastening hole 453 of the second plate 452 but is not fastened to the screw hole 235 of the first hinge mounting bracket 130 and may simply pass therethrough. Accordingly, when a step of the first door 20 is adjusted in vertical and horizontal directions, the first-direction fastening member 630 may freely move in the vertical and horizontal directions within the screw hole 235 without interference in a state of being fastened to the fastening hole 453 of the second plate 452. This allows the first door 20 to move freely in a state in which the first hinge assembly 100 is fixed to the first hinge mounting bracket 130 when the step of the first door 20 is adjusted.

The first door inner bracket 460 and the first hinge mounting bracket 130 may be hook-coupled in a third direction that intersects the first direction and the second direction. In this case, the third direction may be orthogonal to the first direction and the second direction. Accordingly, the first direction, the second direction, and the third direction may intersect to be orthogonal to each other. The third direction may be the horizontal direction.

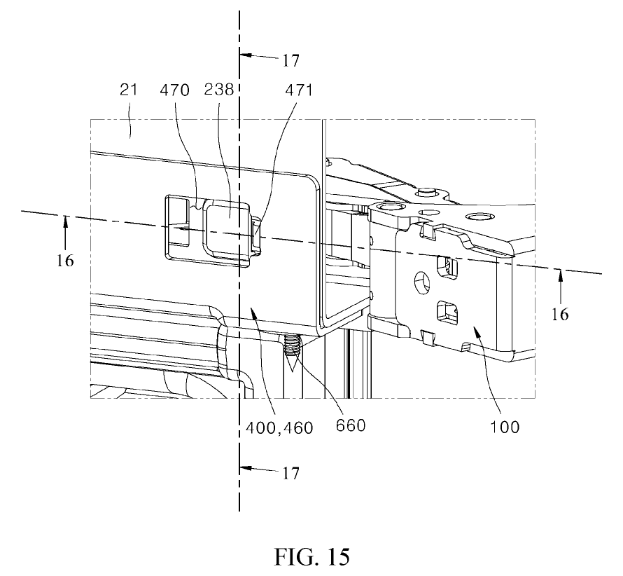

To this end, the first door inner bracket 460 may include a hook portion 471 protruding in the third direction. For example, the hook portion 471 may extend in one direction along the third direction, which is the direction toward the interior of the door, that is, toward the center of the refrigerator. In addition, referring to FIGS. 15-17, the first hinge mounting bracket 130 may include a hook insertion portion 238 that is open to allow the hook portion 471 to be inserted. The hook insertion portion 238 may be opened in the direction in which the hook portion 471 protrudes.

For example, an insertion hole 470 having a portion open may be formed in a front surface of the second plate 452. The insertion hole 470 may be formed adjacent to the portion where the first hinge assembly 100 is fastened. The hook portion 471 may be formed on the second plate 452. For example, the hook portion 471 may be formed to overlap the insertion hole 470 in the front-rear direction. The hook portion 471 may protrude rearward from one side of the insertion hole 470 adjacent to the portion where the first hinge assembly 100 is fastened and may be bent and protruded toward the other side of the insertion hole 470. In this case, a length of the hook portion 471 protruding in the horizontal direction is preferably formed to be shorter than a length of the insertion hole 470 in the horizontal direction.

To allow the first door inner bracket 460 and the first hinge mounting bracket 130 to be hook-coupled in the third direction, an opening 26 that is open so that the hook portion 471 is exposed in a direction toward the interior of the first door 20 may be formed in the front surface of the first upper cap deco 21. In this case, the direction toward the interior of the first door 20 may refer to a rearward direction in the front-rear direction and a direction toward a center of the refrigerator in the horizontal direction. The size of the opening 26 of the first upper cap deco 21 is preferably formed to be greater than the size of the insertion hole 470 of the first door inner bracket 460.

The length of the insertion hole 470 in the third direction is preferably formed to be greater than the length of the hook insertion portion 238. Accordingly, when the hook portion 471 and the hook insertion portion 238 are fastened, the hook insertion portion 238 may be inserted into the front of the open insertion hole 470 and then hook-coupled to the hook portion 471 in a sliding manner in the third direction. In this case, the hook insertion portion 238 may be disposed to overlap the insertion hole 470 in the third direction, and the hook portion 471 may be disposed behind the insertion hole 470 in the third direction.

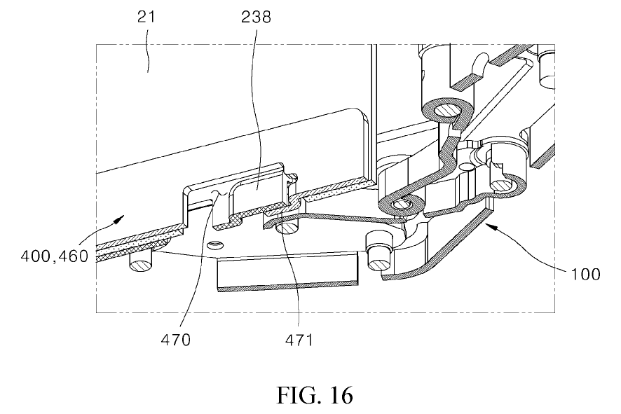

The length of the hook insertion portion 238 in the third direction is preferably formed to be greater than the length of the hook portion 471. Referring to FIG. 16, the length of the hook portion 471 in the horizontal direction may be formed to be smaller than the length of the hook insertion portion 238 in the horizontal direction. That is, a predetermined separation distance is preferably maintained between the open end of the hook insertion portion 238 and an end of the hook portion 471 in the third direction in a state in which the hook portion 471 is inserted into the hook insertion portion 238. Accordingly, when the step of the first door 20 is adjusted in the third direction, a movement space in which the hook portion 471 may move may be formed, and a buffer space may be provided for the risk of damage that may occur when an impact is applied.

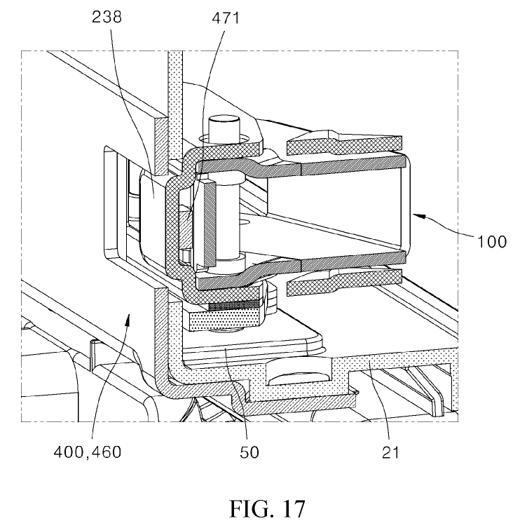

In addition, referring to FIG. 17, the vertical length of the hook portion 471 may be formed to be smaller than the vertical length of the hook insertion portion 238. That is, a predetermined separation distance is preferably maintained between both open ends of the hook insertion portion 238 and both ends of the hook portion 471 in the second direction in a state in which the hook portion 471 is inserted into the hook insertion portion 238. Accordingly, when the step of the first door 20 is adjusted in the second direction, a movement space in which the hook portion 471 may move may be formed, and a buffer space may be provided for the risk of damage that may occur when an impact is applied.

In this way, the hook portion 471 may be fastened to the hook insertion portion 238 formed on the front surface of the first mounting bracket 130 in the horizontal direction, which is the third direction, thereby increasing the fastening force between the first hinge member 110 and the first door inner bracket 460.

As described above, in the refrigerator according to one embodiment of the present disclosure, by additionally providing hook-coupling in the third direction intersecting the first direction and the second direction between the door mounting bracket and the hinge mounting bracket, separation of the bracket can be minimized even under the impact load applied to the door, and the three-axis moment generated during hinge rotation can be stably dispersed.

A guide bent portion 480 bent rearward in the vertical direction at one end of the second plate 452 may be formed. The guide bent portion 480 may be bent rearward at the one end of the second plate 452 that is far from the direction in which the first hinge assembly 100 is located. The guide bent portion 480 may be bent orthogonal to the second plate 452. Accordingly, the guide bent portion 480 may be bent in the same direction to face the bracket bent portion 232 of the first hinge mounting bracket 130. An opening slot portion 27, which vertically extends so that the guide bent portion 480 of the second plate 452 may pass through the first upper cap deco 21 rearward, may be formed in the front surface of the first upper cap deco 21.

A through-hole 481 passing through the guide bent portion 480 in the horizontal direction may be formed in the guide bent portion 480. The through-hole 481 may have a shape that is cut such that a rear portion thereof is open. That is, the through-hole 481 may be cut from a rear end of the guide bent portion 480 such that the open region thereof may be continuously formed. Through the through-hole 481 having the open rear portion in this way, the step adjustment member 620 fastened to the first hinge mounting bracket 130 of the second hinge assembly 200 may be inserted by passing through the through-hole 481 in the front-rear direction. However, the present disclosure is not limited thereto, and after the second hinge assembly 200 is mounted on an upper door lower outer bracket 432, the step adjustment member 620 may be fastened to the first hinge mounting bracket 130 to pass through the through-hole 481 in the horizontal direction.

The diameter of the head portion 621 of the step adjustment member 620 may be formed to be greater than the diameter of the through-hole 481 of the guide bent portion 480. Accordingly, in a state in which the second hinge assembly 200 is mounted on the upper door lower outer bracket 432, a shaft portion 622 of the step adjustment member 620 may pass through the through-hole 481 of the guide bent portion 480, but the head portion 621 of the step adjustment member 620 does not pass through the through-hole 481 of the guide bent portion 480 and may be located outside the guide bent portion 480. That is, in a state in which the second hinge assembly 200 is mounted on the upper door lower outer bracket 432, the second hinge assembly 200 and the shaft portion 622 of the step adjustment member 620 may be disposed in a direction toward an interior of the guide bent portion 480 with respect to the guide bent portion 480, and the head portion 621 of the step adjustment member 620 may be disposed in a direction toward an exterior of the guide bent portion 480 and exposed to the outside. Accordingly, the user can easily rotate the step adjustment member 620 using the head portion 621 of the step adjustment member 620 exposed to the outside. The head portion 621 may be located to be in contact with an outer surface of the guide bent portion 480. The step of the second door 30 may be adjusted in the horizontal direction by adjusting an insertion distance of the shaft portion 622 through the fastening and unfastening of the step adjustment member 620 in the horizontal direction.

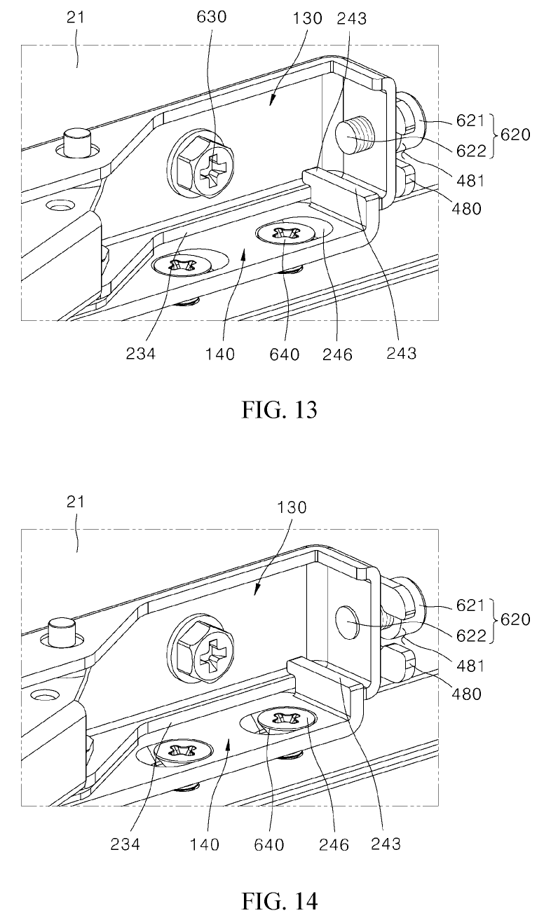

In this case, the step of the door in the horizontal direction may be adjusted by changing the location of the second direction fastening member 640 in the fastening hole 246 having an elongated hole extending in the horizontal direction. For example, referring to FIG. 13, when the first door 20 moves outward from the refrigerator 1 in the horizontal direction, the second direction fastening member 640 may also be moved to be located at one end of the fastening hole 246 adjacent to the outer side of the refrigerator 1. In this case, the distance between the guide bent portion 480 and the bracket bent portion 232 may be reduced. In addition, referring to FIG. 14, when the first door 20 moves in the direction toward the center of the refrigerator 1, that is, toward the interior thereof, in the horizontal direction, the second direction fastening member 640 may also be moved to be located at the other end of the fastening hole 246 adjacent to the inner side of the refrigerator 1. In this case, the distance between the guide bent portion 480 and the bracket bent portion 232 may be increased. In this case, the step adjustment member 620 may be fastened or unfastened to adjust the distance between the guide bent portion 480 and the bracket bent portion 232. In a state in which the second direction fastening member 640 is fastened, the step adjustment member 620 may be tightened to the extent that it may be in contact with the guide bent portion 480, thereby further increasing the fastening force between the hinge assembly and the door mounting bracket.

An extension opening hole 482 extending in the vertical direction may be formed in the through-hole 481. The extension opening hole 482 may extend in one direction along the vertical movement direction of the first door 20. For example, the shaft portion 622 of the step adjustment member 620 passing through the through-hole 481 of the guide bent portion 480 may move in the vertical direction along the extension opening hole 482. Accordingly, the outer diameter of the shaft portion 622 of the step adjustment member 620 may be formed to be smaller than the inner diameter of the extension opening hole 482. Accordingly, the extension opening hole 482 of the guide bent portion 480 may serve to guide the vertical movement of the first hinge assembly 100 to which the step adjustment member 620 is fastened.

In this way, in the refrigerator according to one embodiment of the present disclosure, since the through-hole of the door mounting bracket through which the step adjustment member for adjusting the door step in the horizontal direction passes includes the extension opening hole extending in the vertical movement direction of the door, the vertical and horizontal step adjustments of the door may be substantially controlled integrally at the same location, thereby further improving workability and intuitiveness for step adjustment.

In the refrigerator according to the present disclosure, the step of the door may be adjusted in the vertical direction by means of the step adjustment sheet 500. In this case, each step adjustment sheet 500 may be selectively removed or added in consideration of a step to be adjusted in the vertical direction.

In this way, in the refrigerator according to one embodiment of the present disclosure, more precise vertical step adjustment of the door can be achieved by allowing the step adjustment sheet to be freely separated from the hinge assembly, thereby freely adjusting the number of stacked step adjustment sheets. In addition, when the step adjustment sheet is damaged, only the damaged step adjustment sheet can be easily replaced, thereby enabling ease of replacement and a reduction in maintenance costs.

In the refrigerator according to one embodiment of the present disclosure, precise and easy step adjustment in the vertical direction can be achieved even without complete disassembly of the door by stacking step adjustment sheets in multiple layers or selectively allowing each step adjustment sheet to move to adjust the vertical step of the door.

In addition, since the refrigerator according to one embodiment of the present disclosure includes the step adjustment member that is fastened and unfastened in the horizontal direction of the door, the hinge assembly can precisely adjust not only the vertical step of the door but also the horizontal step of the door.

In addition, in the refrigerator according to one embodiment of the present disclosure, the vertical and horizontal steps of the door may be adjusted through a plurality of step adjustment sheets and step adjustment members in a state in which the hinge member is fixed, thereby preventing a reduction in fastening force between the hinge assembly and the cabinet due to frequent unfastening of the hinge assembly and allowing the step between adjacent doors to be matched more accurately.

Referring to FIG. 18, the first upper cap deco 21 may include the first hinge mounting portion 25 that finishes the front and upper surfaces thereof, and the first door inner bracket 460 disposed on the inner surface of the first upper cap deco 21 may be bent along the front and upper surfaces. In this manner, the lower cap deco may include a hinge mounting portion that finishes front and lower surfaces thereof, and the door inner bracket disposed in the hinge mounting portion may be bent along the front and lower surfaces.

Accordingly, the first hinge assembly 100 may be fastened to the first door inner bracket 460 located on the inner surface of the first door 20 with the first upper cap deco 21 interposed therebetween, and the third hinge assembly 300 may be fastened to the door inner bracket located on the lower inner surface of the second door 30 with the cap deco finishing the lower portion of the second door interposed therebetween.

In addition, in the refrigerator according to one embodiment of the present disclosure, the door mounting bracket can be disposed in the insulation space within the door, and the hinge assembly is mounted with the cap deco interposed therebetween, thereby minimizing the region of the door mounting bracket exposed to the outside and thus not only reducing the risk of damage but also improving the aesthetic appearance of the product.

In the refrigerator according to one embodiment of the present disclosure, the hinge assembly may be fastened to the door mounting bracket in multiple directions including a first direction and a second direction intersecting the first direction, thereby distributing the fastening location and fastening direction. Accordingly, the firm fastening force between the hinge assembly and the door can be secured even in a narrow space. In addition, since the hinge moment can be distributed, the opening and closing force can be made as uniform as possible when the door is opened and closed, and the deformation of the hinge can be reduced.

In this case, the first door inner bracket 460 may be fastened in an integrated manner having a shape that is bent into the inner surface of the first upper cap deco 21. That is, the first door inner bracket 460 may be formed in a first insulation space 28 formed on the inner surface of the first upper cap deco 21.

Accordingly, in the refrigerator according to one embodiment of the present disclosure, by arranging the door mounting bracket in the insulation space within the door, the door mounting bracket can be integrally coupled with the insulating foaming material injected into the insulation space, thereby effectively dispersing an increase and concentration of fatigue at the hinge fastening portion even when the impact load of the door is concentrated on the edge portion of the door.

In addition, in the refrigerator according to one embodiment of the present disclosure, by arranging the door mounting bracket in the insulation space within the door, the door mounting bracket can be pressed by the insulating foaming material filling the insulation space, and thus the location of the door mounting bracket can remain fixed without being changed even when fastening and unfastening between the hinge assembly and the door mounting bracket are repeatedly performed.

In addition, in the refrigerator according to one embodiment of the present disclosure, the door mounting bracket can be formed in the integrated shape having the bent shape that surrounds the front and upper surfaces or front and lower surfaces of the cap deco, thereby simplifying the fastening structure and reducing material costs.

In addition, in the refrigerator according to one embodiment of the present disclosure, by providing the hook coupling structure between the hinge mounting bracket and the hinge mounting plate, the physical stopper effect can be provided during hinge assembly, thereby increasing the pressing force so that the hinge mounting bracket and the hinge mounting plate are more firmly in close contact.

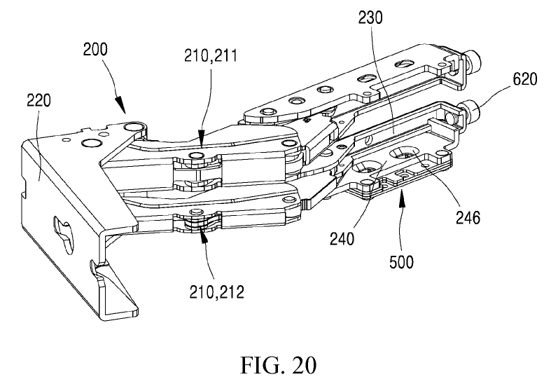

Hereinafter, a hinge assembly including a step adjustment sheet 500 according to another embodiment will be described with reference to FIGS. 19 and 20, and the second hinge assembly 200 will be described as an example.

The second hinge assembly 200 may be disposed between the first door 20 and the second door 30. The second hinge assembly 200 may include a second cabinet mounting bracket 220, and a first hinge member 211 and a second hinge member 212 that may be folded to be stored in the second cabinet mounting bracket 220. That is, the first hinge member 211 and the second hinge member 212 may share a single second cabinet mounting bracket 220. The first hinge member 211 may be disposed above the second hinge member 212. The first hinge member 211 fastened to the lower portion of the first door 20 may be subjected to a stronger load of the door applied in the downward direction than the second hinge member 212 fastened to the upper portion of the second door 30. Accordingly, to allow the strength of the first hinge member 211 to be greater than that of the second hinge member 212, the thickness of the first hinge member 211 is preferably greater than that of the second hinge member 212. The second cabinet mounting bracket 220 may be fastened to a front surface of the barrier portion by one or more fastening members 224.

The first hinge member 211 and the second hinge member 212 may be folded or unfolded independently of each other. That is, the first hinge member 211 and the second hinge member 212 may share the second cabinet mounting bracket 220 fastened to the front surface of the barrier portion 14, thereby increasing space utilization and allowing the opening and closing of the first door 20 and the second door 30 to be performed independently of each other. The first hinge member 211 and the second hinge member 212 of the second hinge assembly 200 may each include the first hinge mounting bracket 130, the first hinge mounting plate 140, and the step adjustment sheet 500 that are separately provided.

A pair of slot guide portions 540 formed to pass through the first step adjustment sheet 510 in the vertical direction may be formed adjacent to both horizontal edges of the first step adjustment sheet 510. The slot guide portions 540 may be extended and penetrated in one direction along the front-rear direction. In the same manner, the pair of slot guide portions 540 may also be formed in each of the second step adjustment sheet 520 and the third step adjustment sheet 530. The slot guide portion 540 may be formed to vertically overlap the fastening hole 245 formed in a protrusion 244 of the plate body portion 241. Accordingly, a plurality of step adjustment sheets 500 may be aligned and stacked such that the fastening hole 245 of each slot guide portion 540 and the protrusion 244 overlap each other.

The step adjustment sheet 500 may be fixed to the lower surface of the first hinge mounting plate 140 by a moving guide member 610 vertically passing through the slot guide portion 540 and the fastening hole 245 of the protrusion 244. For example, the moving guide member 610 may be a rivet member. The moving guide member 610 may further strengthen the bonding force by fixing the step adjustment sheet 500 to the lower surface of the first hinge mounting plate 140 by a rivet fastening method. The moving guide member 610 can effectively prevent the step adjustment sheet 500 from being removed by forming the diameters of both ends thereof to be greater than the diameters of the slot guide portion 540 and the fastening hole 245.

In addition, the moving guide member 610 may guide the movement of each step adjustment sheet 500 in the front-rear direction. Each step adjustment sheet 500 may move horizontally along the moving guide member 610. For example, each step adjustment sheet 500 may be inserted and withdrawn in a sliding manner along the slot guide portion 540 which is opened in the front-rear direction using a pair of moving guide members 610 disposed on both sides as a single axis. In this way, as the plurality of step adjustment sheets 500 are horizontally inserted and withdrawn in a sliding manner, the step adjustment sheets 500 may be moved selectively and independently.

For example, the slot guide portion 540 may be formed to have a closed loop shape that is closed not only in the horizontal direction but also in the front-rear direction. Accordingly, the step adjustment sheet 500 can be prevented from being removed from the first hinge mounting plate 140 during the process of being inserted and withdrawn in the front-rear direction. Accordingly, the step adjustment sheet 500 can be prevented from being lost. In addition, repeatability that may be reproduced in the same manner and operational stability can be improved even when insertion and withdrawal of the step adjustment sheet 500 are repeatedly performed. In this case, the length of the slot guide portion 540 in the front-rear direction may define a maximum insertion and withdrawal distance of the step adjustment sheet 500. In this case, the direction in which the step adjustment sheet 500 is withdrawn may be defined as a direction toward the rear of the second door 30, and the direction in which the step adjustment sheet 500 is inserted may be defined as a direction toward the front of the second door 30.

In a rear region, which is the direction in which each step adjustment sheet 500 is withdrawn, withdrawal holes 511, 521, and 531 passing through in the vertical direction may be formed. For example, a first withdrawal hole 511, a second withdrawal hole 521, and a third withdrawal hole 531 may be formed in the first step adjustment sheet 510, the second step adjustment sheet 520, and the third step adjustment sheet 530, respectively. In this case, the first withdrawal hole 511, the second withdrawal hole 521, and the third withdrawal hole 531 may be formed so as not to overlap each other in the vertical direction. For example, the first withdrawal hole 511 may be disposed to overlap the relief portion 550 disposed on one side thereof in the front-rear direction; the second withdrawal hole 521 may be disposed between a pair of relief portions 550; and the third withdrawal hole 531 may be disposed to overlap the relief portion 550 disposed on the other side in the front-rear direction.

In a stacked state in which the plurality of step adjustment sheets 500 overlap each other, the first withdrawal hole 511, the second withdrawal hole 521, and the third withdrawal hole 531 may all be exposed to the outside in an upward direction. To this end, the second step adjustment sheet 520 and the third step adjustment sheet 530, which are disposed above the first step adjustment sheet 510, may have a cutout portion 560 having an open region overlapping the first withdrawal hole 511 in the vertical direction. In addition, in the third step adjustment sheet 530 disposed above the second step adjustment sheet 520, the cutout portion 560 having the open region overlapping the second withdrawal hole 521 in the vertical direction may be formed. For example, the second step adjustment sheet 520 may have one cutout portion 560, and the third step adjustment sheet 530 may have two cutout portions 560.

In addition, in a state in which the step adjustment sheet 500 is fully inserted, the first withdrawal hole 511, the second withdrawal hole 521, and the third withdrawal hole 531 may be disposed so as not to overlap the protrusion 244 of the first hinge mounting plate 140. For example, the first withdrawal hole 511, the second withdrawal hole 521, and the third withdrawal hole 531 may be disposed between a pair of protrusions 244. In this case, the first withdrawal hole 511, the second withdrawal hole 521, and the third withdrawal hole 531 may be arranged side by side with the pair of protrusions 244 in the horizontal direction.

As described above, the first withdrawal hole 511, the second withdrawal hole 521, and the third withdrawal hole 531 formed in each step adjustment sheet 500 may serve as guide holes used to independently insert and withdraw each step adjustment sheet 500. For example, a user may insert and withdraw each step adjustment sheet 500 using a mechanism inserted into each withdrawal hole. Accordingly, the user may insert the mechanism into the first withdrawal hole 511 when inserting and withdrawing the first step adjustment sheet 510, insert the mechanism into the second withdrawal hole 521 when inserting and withdrawing the second step adjustment sheet 520, and insert the mechanism into the third withdrawal hole 531 when inserting and withdrawing the third step adjustment sheet 530.

When some of the plurality of step adjustment sheets 500 are withdrawn, the step adjustment sheet that is closer to the upper or lower surface of the door than the hinge mounting plate may be withdrawn preferentially. In addition, when some of the plurality of step adjustment sheets 500 are inserted, the step adjustment sheet that is closer to the hinge mounting plate than the upper or lower surface of the door may be inserted preferentially.

In this way, by withdrawing the first step adjustment sheet 510, the step of the first door 20 may be adjusted in the vertical direction by the vertical thickness of the first step adjustment sheet 510. That is, the first door 20 may be moved upward by the vertical thickness of the first step adjustment sheet 510.

The insertion and withdrawal of the step adjustment sheet 500 of the first hinge assembly 100 fastened to the upper portion of the first door 20 and the insertion and withdrawl of the step adjustment sheet 500 of the first hinge member 211 of the second hinge assembly 200 fastened to the lower portion of the first door 20 may be synchronized with each other. For example, since the first hinge assembly 100 supports the upper portion of the first door 20 and the first hinge member 211 of the second hinge assembly 200 supports the lower portion of the first door 20, the movement distance of the first door 20 moving upward or downward can be accurately and finely controlled by inserting or withdrawing the step adjustment sheets located in each hinge assembly in equal numbers.

Likewise, the insertion and withdrawal of the step adjustment sheet 500 of the second hinge member 212 of the second hinge assembly 200 fastened to the upper portion of the second door 30 and the insertion and withdrawal of the step adjustment sheet 500 of the third hinge assembly 300 fastened to the lower portion of the second door 30 may be synchronized with each other. For example, since the second hinge member 212 of the second hinge assembly 200 supports the upper portion of the second door 30 and the third hinge assembly 300 supports the lower portion of the second door 30, the movement distance of the second door 30 moving upward or downward can be accurately and finely adjusted by inserting or withdrawing the step adjustment sheets located in each hinge assembly in equal numbers.

Although the present disclosure has been described above with reference to the exemplary drawings, the present disclosure is not limited by the embodiments and drawings disclosed in the present specification, and it is obvious that various modifications can be made by those skilled in the art within the scope of the technical spirit of the present disclosure. In addition, even when the operational effects according to the configuration of the present disclosure have not been explicitly described in the description of the embodiments of the present disclosure, it goes without saying that the effects predictable by the corresponding configuration should be recognized.

What is claimed is:

1. A refrigerator comprising:
a cabinet including one or more storage compartments;
one or more doors configured to open and close the storage compartments;
a hinge assembly connected to the door and the cabinet so that the door is rotatable from the cabinet; and
a door mounting bracket disposed on an inner surface of a cap deco configured to finish an upper or lower surface of the door,
wherein the hinge assembly is fastened to the door mounting bracket in a first direction and a second direction intersecting the first direction with the cap deco interposed therebetween.

2. The refrigerator of claim 1, wherein the door mounting bracket has a bent shape to surround a front surface and an upper surface or the front surface and a lower surface of the cap deco.

3. The refrigerator of claim 1, wherein the door mounting bracket is located within an insulation space formed within the door.

4. The refrigerator of claim 1, wherein the hinge assembly includes:
a hinge member including a plurality of joints; and
a hinge mounting bracket and a hinge mounting plate which fasten the hinge member to the door mounting bracket in the first direction and the second direction, respectively.

5. The refrigerator of claim 4, wherein the door mounting bracket and the hinge mounting bracket are coupled by a first direction fastening member which is fastened and unfastened in the first direction.

6. The refrigerator of claim 4, wherein the hinge mounting plate, the cap deco, and the door mounting bracket are coupled by a second direction fastening member which is fastened and unfastened in the second direction.

7. The refrigerator of claim 4, wherein a plurality of step adjustment sheets are disposed between the hinge mounting plate and the cap deco to adjust a vertical step of the door through movement or separation thereof.

8. The refrigerator of claim 7, wherein the step adjustment sheet includes a relief portion through which a second direction fastening member passes and which does not interfere with the second direction fastening member when the step adjustment sheet is moved or separated.

9. The refrigerator of claim 4, wherein the hinge mounting plate includes a catch portion which is hook-coupled to the hinge mounting bracket in the second direction, and
the catch portion presses the hinge mounting bracket in a direction in which a second direction fastening member is fastened.

10. The refrigerator of claim 4, further comprising a second direction fixing member passing through the hinge mounting bracket, the hinge member, and the hinge mounting plate in the second direction,
wherein the second direction fixing member is a rivet fastening member.

11. The refrigerator of claim 10, wherein a gap adjustment sheet is further disposed between the hinge member and the hinge mounting plate, and
the second direction fixing member passes through the gap adjustment sheet.

12. The refrigerator of claim 4, wherein the door mounting bracket and the hinge mounting bracket are hook-coupled in a third direction intersecting the first direction and the second direction.

13. The refrigerator of claim 12, wherein the door mounting bracket includes a hook portion protruding in a direction toward an interior of the door,
a front surface of the cap deco includes an opening which is open such that the hook portion is exposed in the direction toward the interior of the door, and
the hinge mounting bracket includes a hook insertion portion which is open such that the hook portion is inserted.

14. The refrigerator of claim 13, wherein a length of the hook insertion portion in the third direction is greater than a length of the hook portion.

15. The refrigerator of claim 13, wherein the door mounting bracket includes an insertion hole communicating with the opening,
the hook portion is formed on one side of the insertion hole to protrude in a direction toward a center of the door, and
a length of the insertion hole in the third direction is greater than a length of the hook insertion portion.

16. The refrigerator of claim 4, wherein the hinge assembly includes a step adjustment member which is fastened and unfastened in a third direction intersecting the first direction and the second direction to adjust a horizontal step of the door, and
the step adjustment member is disposed on one side of the hinge mounting bracket.

17. The refrigerator of claim 16, wherein the door mounting bracket includes a guide bent portion protruding in a direction toward an interior of the door,
a front surface of the cap deco includes an opening slot portion which is open to allow the guide bent portion to pass through the opening slot portion in the direction toward the interior of the door, and
the guide bent portion includes a through-hole through which the step adjustment member passes.

18. The refrigerator of claim 17, wherein the through-hole includes an extended opening hole extending in one direction along a vertical movement direction of the door.

19. A refrigerator comprising:
a cabinet including an upper storage compartment and a lower storage compartment;
an upper door and a lower door which respectively open and close the upper storage compartment and the lower storage compartment; and
an upper hinge assembly and a lower hinge assembly fixed to an upper surface of the upper door and a lower surface of the lower door, respectively,
wherein the upper hinge assembly is fastened to front and upper surfaces of an upper door inner bracket disposed on an upper inner surface of the upper door, and
the lower hinge assembly is fastened to front and lower surfaces of a lower door inner bracket disposed on a lower inner surface of the lower door.

20. The refrigerator of claim 19, wherein the upper hinge assembly and the lower hinge assembly are single fastening hinge assemblies, and
the upper door inner bracket and the lower door inner bracket are located in insulation spaces formed within the upper door and the lower door, respectively.
